(19) United States
(12) Patent Application Publication
(10) Pub. No.: US 2003/0116979 A1
(43) Pub. Date: Jun. 26, 2003

(54) Motor vehicle door lock plate

(76) Inventors: Laurent Arquevaux, Sully Sur Loire (FR); Mathilde Baudet, Aubigny Sur Nere (FR); Simon Dobson, Sandgate-Folkestone (GB); Rainer Grimm, (US); Jacky Mercier, Bonnee (FR); Yves Tronel, Sully Sur Loire (FR)

Correspondence Address: CARLSON, GASKEY & OLDS, P.C., 400 WEST MAPLE ROAD, SUITE 350, BIRMINGHAM, MI, 48009, US

(21) Appl. No.: 10/325,216

(22) Filed: Dec. 20, 2002

(30) Foreign Application Priority Data
Dec. 26, 2001 (FR) 01 16 862

(51) Int. Cl. E05B 9/00

(52) U.S. Cl. 292/337

(57) ABSTRACT

A motor vehicle door lock plate is provided, the plate (10) comprising a first part (14) with a slot (12), the slot (12) opening at one end of the first part (14), and a second part (16) for fixing the plate, the second part (16) being angled with respect to the first part and being at an opposite end of the first part to the end at which the slot opens. The plate has the advantage of allowing the lock to be fixed to a vehicle door the structure of which is such that the skin of the door is not able to take up the forces generated by operation of the door lock.

### BACKGROUND OF THE INVENTION

The present application claims priority to French Patent Application No. 01 16 862, filed Dec. 26, 2001.

The present invention relates to a motor vehicle door lock plate and more particularly to a plate for fixing the lock to the door of the vehicle.

Motor vehicle one-piece doors obtained by pressing have a lock arranged in the door cavity and fixed to the internal skin of the door, to the rear face thereof. The lock is fixed by a fixing plate and a reinforcement. Typically, fixing is provided by screws. The screws pass through the rear face of the door to engage with the fixing plate.

U.S. Pat. No. 6,024,389 discloses such a motor vehicle door lock fixing. The lock comprises a pivoting finger and a fixed peg. The finger is arranged in a casing fixed to the internal skin of the door, to the rear face thereof, by a fixing plate and three screws. The screws penetrate from outside the door through the rear face thereof. The peg is fixed to the frame of the door. The casing has a slot in which the peg engages so that the finger engages in the peg when the door is slammed.

There are types of door in which the skin acts as a covering and is applied to a bearing structure. The skin of these types of door is not able to withstand the forces generated by the operation of the lock.

In consequence, there is a need for a means of fixing a lock to motor vehicle doors exhibiting a structure in which the skin of the door cannot take the forces generated by the operation of the lock.

### SUMMARY OF THE INVENTION

For that, the invention proposes a motor vehicle door lock plate, the plate comprising

a first part with a slot, the slot opening at one end of the first part, and

a second part for fixing the plate, the second part being angled with respect to the first part.

Advantageously, the second part is perpendicular to the first part. The second part may comprise at least one fixing hole.

Preferably, the second part is at an opposite end of the first part to the one to which the slot opens.

There may be a rib between the first part and the second part.

In one embodiment, the plate further comprises a third part connected to the second part, the third part being substantially parallel to the first part. Advantageously, there is a rib between the second part and the third part.

The invention also relates to a motor vehicle door comprising a plate as described hereinabove. The door may further comprise a skin and a rigid member under the skin, the plate being fixed to the member.

Advantageously, the plate is fixed to the member by at least one fastener. The fastener may be a screw or a rivet. The fastener may be fixed in a direction substantially parallel to the direction in which the door is opened.

The invention also relates to a method of manufacturing a plate as described hereinabove, the method comprising a step of drawing the plate.

The plate according to the invention has the advantage that it can be fixed to a rigid member of the door; fixing the plate to this member allows the forces experienced by the plate, for example in the event of a collision, to be transmitted to this member. Inclining one part of the plate with respect to the other allows the plate to fit the location of the rigid member in the door.

Other features and advantages of the invention will become apparent from reading the detailed description which follows of some embodiments of the invention which are given solely by way of example and with reference to the drawings.

### BRIEF DESCRIPTION OF THE DRAWINGS

FIG. 1 depicts a perspective view of a lock plate according to the invention;

FIG. 2 depicts the plate of FIG. 1 in cross section, fixed to a vehicle door;

FIG. 3 depicts a perspective view of a lock plate according to another embodiment;

FIG. 4 depicts a perspective view of a lock plate according to yet another embodiment.

### DETAILED DESCRIPTION OF PREFERRED EMBODIMENTS

In the types of door where the skin is a covering applied to a bearing structure of the door, recourse cannot be had to the fixing of the lock to the rear face of the door. This is because, in this type of door, the skin is unable to withstand the forces generated by the presence and operation of the lock or to take the forces experienced by the plate and the lock, for example in the event of an accident.

The invention proposes a lock plate which can be fixed to a rigid member of a vehicle door. For that, the plate comprises at least two parts with an angle between them. This plate allows the lock to be fixed to the door, mating with the rigid member to which the plate is fixed.

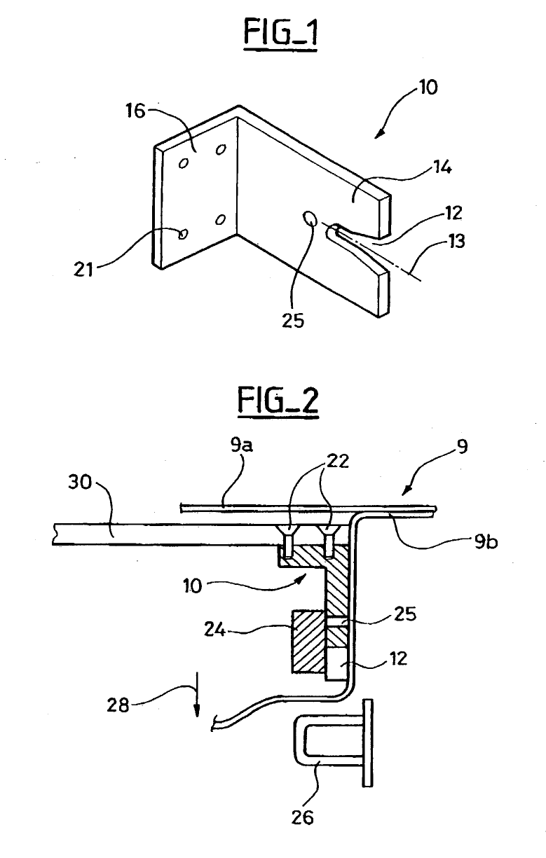

FIG. 1 depicts a perspective view of a lock plate 10. The lock is not depicted. The plate 10 comprises a first part 14, forming a first plane, with a slot 12. The slot 12 is an opening longer than it is wide, through the thickness of the plate 10. The slot 12 opens to one end of the first part 14. Along its longest dimension, the slot 12 has a longitudinal axis 13. The slot 12 allows the plate 10 to house a peg and to block its translation at least towards the closed end of the slot 12 and in a direction perpendicular to the longitudinal axis 13 of the slot. The slot has a tapered shape, widening towards the end of the plate 10 at which the slot 12 opens. The tapered shape of the slot eases the introduction of the peg into the slot.

In FIG. 1, the plate 10 also comprises a second part 16 for fixing which is angled with respect to the first part 14. Advantageously, the second part 16 exhibits, starting from the first part 14, an angle between 45° and 135°. The second part 16 is typically perpendicular to the first part 14. The angle of the second part 16 allows the plate to be fitted to a rigid door member, according to the position and angle of this member. This has the advantage of offering various options for fixing the lock to the door.

The second part 16 is obtained for example by drawing the plate 10, which initially was flat. In FIG. 1, the second part is a portion of the plate 10; the second part 16 may also be in the form of one or more lugs. The advantage of lugs is that they limit the amount of material used and thus reduce the cost of manufacture of the plate.

In one example, the plate 10 may have the following dimensions: a thickness of from 5 to 6 mm, a length of 90 mm and a width of 70 mm. The plate 10 may be drawn along its longest dimension so that 60 mm of the length of the plate 10 correspond to the first part 14 and 30 mm of the length of the plate 10 correspond to the second part 16.

The slot 12 for example has a length of 25 mm. The plate is made for example of steel or of titanium.

The second part 16 comprises at least one fixing hole 21. Advantageously, the hole 21 is threaded. In FIG. 1, four holes 21 are depicted for purposes of illustration and not limitation. The holes allow the plate 10 to be fixed by at least one fastener 22 (FIG. 2). The fastener 22 employed is, for example, a screw or a rivet. Advantageously, the plate is fixed by a number of fastener 22 which pass through a rigid member on which the plate is immobilized and enter the holes 21 which are threaded for that purpose.

The axis of drilling of the holes 21 depends on the orientation of the rigid member on which the plate 10 is fixed. This allows the fixing of the plate to be fitted to the position and the angle of the rigid member. The axis of drilling of the holes 21 may also be dependent on the axis along which the fastener take the forces due to the operation of the lock. FIG. 1 depicts an advantageous embodiment of the plate 10. The first and second parts 14, 16 are mutually perpendicular and the holes 21 are made along an axis parallel to the longitudinal axis 13 of the slot 12. The axis of the fastener 22 is then parallel to the plane of the first part 14 and, more particularly, parallel to the longitudinal axis 13 of the slot 12. When a peg enters the slot 12 substantially along the longitudinal axis 13, the plate 10 is stressed in a direction parallel to the plane of the first part 16. More specifically, when a peg is in the slot 12 and the plate 10 is urged in a direction parallel to the longitudinal axis 13 of the slot 12 the fastener 22 are then advantageously stressed in tension rather than in bending or in shear. The configuration of the plate 10 with a right angle has the advantage of offering the fastener and the plate 10 greater resistance to wear.

Advantageously, the second part 16 is at an opposite end of the first part 14 to the end to which the slot 12 opens. This arrangement simplifies the construction of the plate 10 because the plate can be drawn at one end and slit at the opposite end without changing the position of the plate 10 on the manufacturing tooling.

FIG. 2 depicts a motor vehicle door with the lock plate 10, in section along the longitudinal axis 13 of the slot 12. The door has an external skin 9a and an internal skin 9b. The skins 9a, 9b define, inside the door 9, a cavity in which the door lock and the lock plate 10 are housed. The lock member located on the door and fixed to the plate 10 is depicted schematically by the member referenced 24. It will be understood that the angle between the first and second parts 14, 16 also depends on the dimensions of the lock member 24 fixed to the plate 10. The lock member 24 comprises a lock finger pivoting about an axis passing through the orifice 25. The finger engages with a lock peg 26 situated on the frame of the door 9. The lock finger is not depicted. In the type of door depicted, the door comprises a rigid member 30 along one of its lateral faces. The member 30 may, however, occupy some other position and have some other angle. The plate 10 allows the lock to be fixed to this member 30 able to withstand the forces generated by the operation of the lock. In particular, when the vehicle is involved in a collision against one of its doors, the compressive forces generated in the lock and in the plate 10 are taken up by the rigid member 30 of the door. Fixing the plate 10 to a rigid member of the door offers greater passenger safety. As a preference, the plate 10 can be fixed to an member of the bearing structure of the door, such as a reinforcing bar for example. The plate 10 is fixed to the member 30 by at least one fastener 22. Two screws are depicted as fasteners 22 in FIG. 2, but any number and type of fasteners 22 can be used. The fastener 22 are fixed in a direction substantially tangential to the circular movement of the door; near the peg 26, the axis of fixing of the fastener 22 is therefore in a direction substantially parallel to the direction in which the door is opened. This allows the fastener to experience the forces in the direction of opening, near the peg 26.

The plate 10 allows the lock to operate as follows. When the door 9 is closed in the direction indicated by the arrow 28, the peg 26 engages in the slot 12. The lock finger pivots and engages with the peg 26. The lock finger pivots for example into contact with the peg 26. When the lock finger is in engagement with the peg 26, the lock is immobilized and the door is held closed. The lock finger can no longer pivot or release the peg 26. Only action on a door handle allows the lock finger to be released from the peg 26.

When the second part 16 is advantageously perpendicular to the first part 14, the plate 10 offers the advantage of allowing the fastener 22 to work in tension when the door 9 is opened.

Thus, when the door 9 is closed, the lock finger comes into contact with the peg 26 before pivoting. The member 24 and the plate 10 are urged in the opposite direction to the one indicated by the arrow 28. The plate 10 is then stressed in compression. Likewise, when the vehicle is involved in a side impact into the door 9, the plate 10 is also stressed in compression. In all these loading scenarios, the compressive forces are transmitted to the rigid member 30.

Conversely, when the door is opened, or the door is stressed in the opening direction (for example when a passenger strikes the door hard following a collision), the plate 10 and the fastener 22 are stressed in tension. In the case of a collision of the vehicle, the plate 10 is able to withstand forces of 35 kN. As the plate 10 is fixed to the rigid member 30, the tensile forces are transmitted to the member 30.

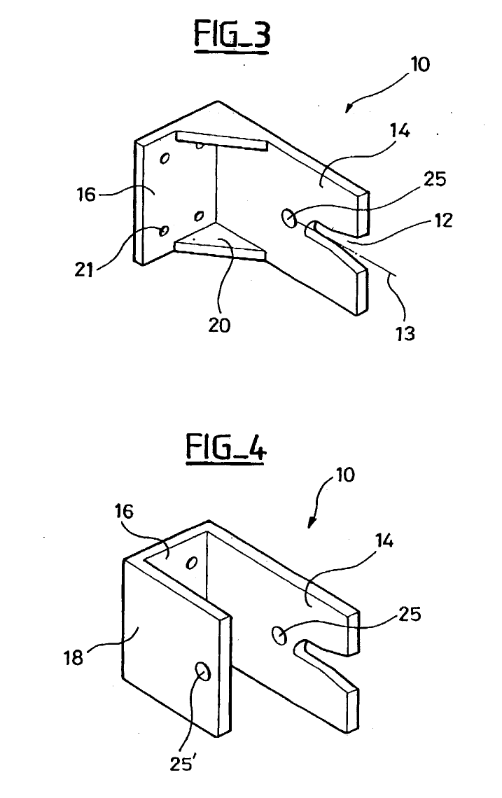

FIG. 3 depicts a perspective view of the plate 10 with ribs 20. The ribs stiffen the plate 10. In FIG. 3., two ribs are depicted for illustrative purposes only. It is possible to envisage the use of more or fewer ribs. The ribs 20 are, for example, welded to the two parts 14, 16. The ribs can also be pressed at the same time as the parts 14, 16.

FIG. 4 depicts another embodiment of the plate 10. In this embodiment, the plate 10 further comprises a third part 18 connected to the second part 16, the third part being parallel to the first part 14. As the angle between the first and second parts is between 45° and 135°, the angle between the second and third parts is then the supplementary angle of the first. In FIG. 4, the three parts are advantageously perpendicular to one other. In FIG. 4, the third part 18 is situated at an opposite end of the second part 16 to the end at which the first part 14 is located. This is particularly advantageous for the construction of the plate 10, in a drawing method for example. The third part 18 may also be attached by welding, at a location other than the end of the second part 16. The parallelism between the first and third parts 14, 18 allows the lock to be fixed to these two parts, which further improves the rigidity of the assembly. The third part 18 has an orifice 25′ facing the orifice 25 of the first part 14. The orifices 25 and 25′ are intended to receive the pin about which the lock finger pivots. Thus, the pin about which the lock finger pivots is not stressed in cantilever fashion. It is also possible to envisage welding two successive parts 14, 16, 18 with ribs, so as to further stiffen the assembly.

It should be understood that various alternatives to the embodiments of the invention described herein may be employed in practicing the invention. It is intended that the following claims define the scope of the invention and that the method and apparatus within the scope of these claims and their equivalents be covered thereby.

What is claimed is:

1. A motor vehicle door lock plate, comprising:
a first part having a slot disposed at a first end of the first part, and
a second part connected to a second end of the first part, wherein the second end is opposite the first end, and wherein the second part is disposed at an angle with respect to the first part, the second part adapted to fix the lock plate to the vehicle door.

2. The plate according to claim 1, wherein the second part is perpendicular to the first part.

3. The plate according to claim 1, further comprising at least one fixing hole in the second part.

4. The plate according to claim 1, further comprising at least one rib disposed between the first part and the second part.

5. The plate according to claim 1, further comprising a third part connected to the second part, wherein the third part is substantially parallel to the first part.

6. The plate according to claim 5, further comprising at least one rib disposed between the second part and the third part.

7. A motor vehicle door, comprising:
a door lock plate, the plate comprising
a first part having a slot disposed at a first end of the first part, and
a second part connected to a second end of the first part, wherein the second end is opposite the first end, and wherein the second part is disposed at an angle with respect to the first part, the second part being fixed to the motor vehicle door.

8. The motor vehicle door according to claim 6, wherein the second part is perpendicular to the first part.

9. The motor vehicle door according to claim 6, further comprising at least one fixing hole in the second part.

10. The motor vehicle door according to claim 6, further comprising at least one rib disposed between the first part and the second part.

11. The motor vehicle door according to claim 6, further comprising a third part connected to the second part, wherein the third part is substantially parallel to the first part.

12. The motor vehicle door according to claim 11, further comprising at least one rib disposed between the second part-and the third part.

13. The motor vehicle door according to claim 6, further comprising:
a skin; and
a rigid member disposed under the skin, wherein the door lock plate is fixed to the rigid member.

14. The motor vehicle door according to claim 13, further comprising at least one fastener that fixes the door lock plate to the rigid member.

15. The motor vehicle door according to claim 6, wherein the fastener is a screw.

16. The motor vehicle door according to claim 14, wherein the fastener is a rivet.

17. The motor vehicle door according to claim 14, wherein the fastener is fixed in a direction substantially parallel to the direction in which the door is opened.

18. A method for manufacturing a motor vehicle door lock plate, comprising:
drawing the plate;,
forming the plate into a first part and a second part, wherein the second part is disposed at an angle with respect to the first part and is adapted to fix the lock plate to the vehicle door; and
forming a slot at a first end of the first part.

19. The method according to claim 18, further comprising forming at least one rib disposed between the first part and the second part.

20. The method according to claim 19, wherein said at least one rib is formed by a process selected from the group consisting of pressing and welding.

21. The method according to claim 18, further comprising forming a third part connected to the second part, wherein the third part is substantially parallel to the first part.

22. The method according to claim 18, wherein the third part formed by attaching the third part to the second part by welding.

23. The method according to claim 18, further comprising at least one rib disposed between the second part and the third part.

24. The method according to claim 23, wherein said at least one rib is formed by a process selected from the group consisting of pressing and welding.
